(19) United States
(12) Patent Application Publication
(10) Pub. No.: US 2021/0123746 A1
(43) Pub. Date: Apr. 29, 2021

(54) ELECTRONIC DEVICE FOR DETECTING LOCATION AND METHOD THEREOF

(71) Applicant: SAMSUNG ELECTRONICS CO., LTD., Suwon-si (KR)

(72) Inventors: Dukhyun CHANG, Suwon-si (KR); Taeyoon KIM, Suwon-si (KR); Youngpo LEE, Suwon-si (KR); Hyeonggeon LEE, Suwon-si (KR); Chaiman LIM, Suwon-si (KR)

(21) Appl. No.: 17/012,401

(22) Filed: Sep. 4, 2020

(30) Foreign Application Priority Data
Oct. 25, 2019 (KR) 10-2019-0133912

(51) Int. Cl. G01C 21/20; G01S 1/68; G01C 21/16

(52) U.S. Cl. CPC G01C 21/206; G01C 21/165; G01S 1/68

(57) ABSTRACT

Disclosed is an electronic device including: a sensor module comprising at least one sensor configured to detect sensing data including a magnetic signal, movement of the electronic device, acceleration of the electronic device, and/or an angle orientation of the electronic device with respect to a ground, a memory configured to store a virtual marker platform, and a processor operatively connected to the sensor module and the memory, wherein the processor is configured to control the electronic device to: receive the sensing data from the sensor module, generate a first virtual marker corresponding to a first location corresponding to a current location of the electronic device using the sensing data, store the first virtual marker in the memory, detect an arbitrary virtual marker, load the first virtual marker from the memory, and request a specified service and/or perform an event designated to be performed in the first location by the electronic device based on the arbitrary virtual marker matching the first virtual marker.

### CROSS-REFERENCE TO RELATED APPLICATION

This application is based on and claims priority under 35 U.S.C. § 119 to Korean Patent Application No. 10-2019-0133912, filed on Oct. 25, 2019, in the Korean Intellectual Property Office, the disclosure of which is incorporated by reference herein in its entirety.

### BACKGROUND

### Field

The disclosure relates to an electronic device for detecting a location and a method thereof.

### Description of Related Art

Electronic devices may track locations of the electronic devices and/or users using methods such as positioning and/or localization in order to notify the locations of the electronic devices.

Centimeter-level accuracy may be required for positioning and/or localization in an indoor place. Therefore, electronic devices may use a Bluetooth beacon signal or Wi-Fi signal having higher accuracy than that of a GPS technology in order to precisely measure the locations of the electronic devices.

Furthermore, electronic devices may provide a service based on a geofencing method in which whether entry to and/or exit from a specific point of interest (PoI) is performed is determined, in order to notify the locations of the electronic devices in an indoor place.

In order to perform location detection using positioning and/or localization, electronic devices may require an indoor map provided externally or generated through algorithms included in the electronic devices and/or a fingerprint map in which sensor values are measured from multiple points on a map. In cases when electronic devices require an indoor map and/or a fingerprint map in order to perform location detection, latency may occur during data processing since electronic devices transmit/receive a large amount of data.

A method in which electronic devices use Bluetooth beacon signals in order to perform location detection may require installation of additional infrastructure such as a Bluetooth beacon generator. A preliminary task for supplying corresponding processors may be required in order to apply an indoor positioning technology based on Wi-Fi signals such as 802.11mc or RTT of wireless LAN. If indoor location measurement requires installation of infrastructure or requires a preliminary task, it may not be easy to spread indoor location measurement services.

In cases when electronic devices use a geofencing method, the services may be provided using a relatively small amount of data since it is not necessary to specify coordinates. However, such cases may require installation of additional dedicated infrastructure such as Bluetooth beacon if higher precision and accuracy are required.

### SUMMARY

Embodiments of the disclosure provide a technology for determining whether entry to and/or exit from a specific point of interest is performed and for indoor positioning and/or localization for measuring a location by an electronic device based on an indoor magnetic field.

In accordance with an example embodiment of the present disclosure an electronic device is provided. The electronic device includes: a sensor module comprising at least one sensor configured to detect sensing data including a magnetic signal, movement of the electronic device, acceleration of the electronic device, and/or an angle orientation of the electronic device with respect to a ground, a memory configured to store a virtual marker platform, and a processor operatively connected to the sensor module and the memory, wherein the processor is configured to control the electronic device to: receive the sensing data from the sensor module, generate a first virtual marker corresponding to a first location corresponding to a current location of the electronic device using the sensing data, store the first virtual marker in the memory, detect an arbitrary virtual marker, load the first virtual marker from the memory, and request a specified service and/or perform an event designated to be performed in the first location by the electronic device based on the arbitrary virtual marker matching the first virtual marker.

In accordance with another example embodiment of the present disclosure, a method for detecting a virtual marker corresponding to a location of an electronic device is provided. The methods includes: receiving sensing data including a magnetic signal, movement of the electronic device, acceleration of the electronic device, and/or an angle orientation of the electronic device with respect to a ground, generating a first virtual marker corresponding to a first location corresponding to a current location of the electronic device using the sensing data, and storing the first virtual marker.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a diagram illustrating an example one-dimensional virtual marker according to an embodiment;

FIG. 3 is a diagram illustrating an example method of setting virtual markers on particular locations according to an embodiment;

FIG. 4 is a diagram illustrating an example method of setting virtual markers in a particular path according to an embodiment;

FIG. 5 is a diagram illustrating example sensing values measured on a two-dimensional plane mapped to a two-dimensional virtual marker according to an embodiment;

FIG. 6 is a diagram illustrating example imaged data of two-dimensional virtual markers generated using magnetic field values measured by an electronic device according to an embodiment;

FIG. 7 is a flowchart illustrating an example framework of virtual markers according to an embodiment;

FIG. 8 is a diagram illustrating an example operation of registering, storing, and/or loading a virtual marker according to an embodiment;

FIG. 9 is a block diagram illustrating an example virtual marker platform according to an embodiment;

FIG. 10 is a signal flow diagram illustrating an example process of registering virtual markers according to an embodiment;

FIG. 11 is a signal flow diagram illustrating an example process of loading virtual markers according to an embodiment;

FIG. 12 is a signal flow diagram illustrating an example operation in which a virtual marker platform detects a virtual marker according to an embodiment;

FIG. 13 is a flowchart illustrating an example operation in which an electronic device generates a first virtual marker and detects a virtual marker to perform a specified event or request a specified service according to an embodiment; and

FIG. 14 is a flowchart illustrating an example operation in which an electronic device receives sensing data and generates and stores a first virtual marker according to an embodiment.

### DETAILED DESCRIPTION

Hereinafter, various example embodiments of the disclosure will be described in greater detail with reference to the accompanying drawings. However, it should be understood that the disclosure is not limited to specific embodiments, but rather includes various modifications, equivalents and/or alternatives of various embodiments of the present disclosure.

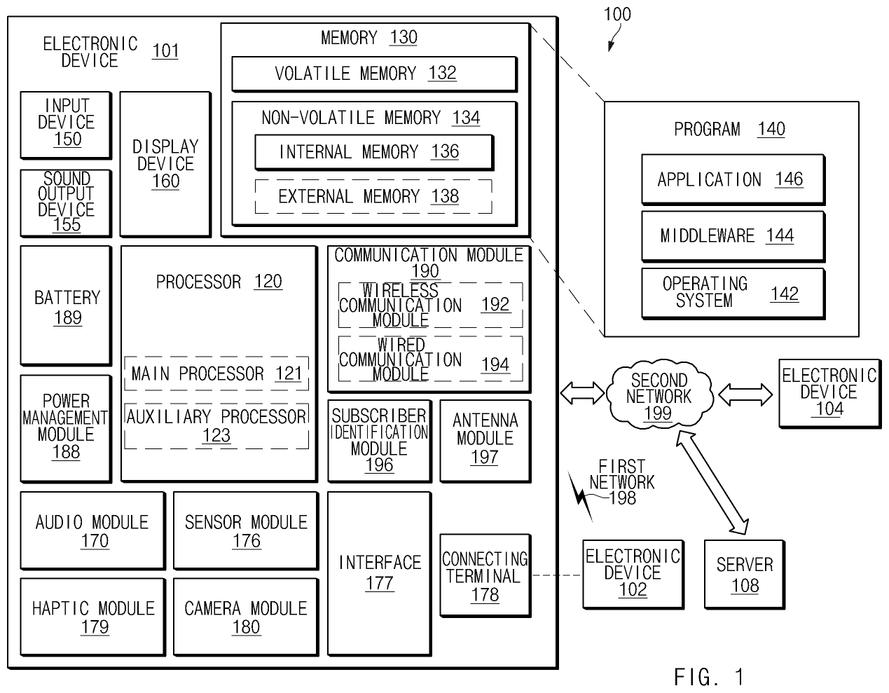

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an example embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an example embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

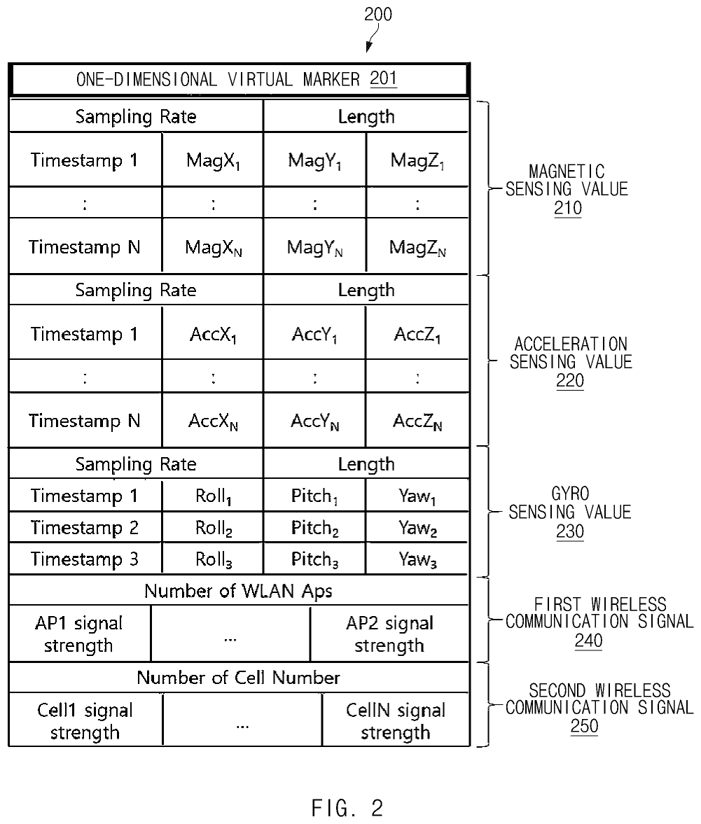

FIG. 2 is a diagram 200 illustrating an example one-dimensional virtual marker 201 according to an embodiment.

Referring to FIG. 2, the one-dimensional virtual marker 201 may include sensing values including one-dimensional linear information in a virtual marker (VM) for displaying information about a particular space and/or location. The one-dimensional virtual marker 201 may be stored in a memory (e.g., the memory 130 of FIG. 1) of an electronic device (e.g., the electronic device 101 of FIG. 1). The one-dimensional virtual marker 201 may include, for example, and without limitation, a magnetic sensing value 210, an acceleration sensing value 220, a gyro sensing value 230, a first wireless communication signal 240, and/or a second wireless communication signal 250.

In an embodiment, the magnetic sensing value 210 may include a magnitude value of a magnetic field for each direction measured at a particular rate in a particular space and/or location according to a specified sampling rate. Regarding the magnetic sensing value 210, a time during which the magnitude value of a magnetic field for each direction is measured one time may be set according to a specified length. For example, when the sampling rate is 1 Hz and the length is 0.1 seconds, the electronic device 101 may measure the magnitude value of a magnetic field for each direction every one second. Measurement of the magnitude value of a magnetic field for each direction may be maintained for 0.1 seconds while the measurement may be performed one time. The electronic device 101 may measure a magnetic field in a particular space and/or location using a magnetic field sensor included in a sensor module (e.g., the sensor module 176 of FIG. 1). For example, the sensor module 176 may measure a magnetic field from a first time Timestamp 1 to an nth time Timestamp N (N being a natural number). In this case, the magnetic sensing value 210 may include an X-axial direction strength MagX₁ of the magnetic field measured at the first time Timestamp 1, a Y-axial direction strength MagY₁ of the magnetic field measured at the first time Timestamp 1, and a Z-axial direction strength MagZ₁ of the magnetic field measured at the first time Timestamp 1. Furthermore, the magnetic sensing value 210 may include an X-axial direction strength MagX_{N} of the magnetic field measured at the Nth time Timestamp N, a Y-axial direction strength MagY_{N} of the magnetic field measured at the Nth time Timestamp N, and a Z-axial direction strength MagZ_{N} of the magnetic field measured at the Nth time Timestamp N.

In an embodiment, the acceleration sensing value 220 may include a magnitude value of acceleration of the electronic device 101 for each direction measured at a particular rate in a particular space and/or location according to a specified sampling rate. Regarding the acceleration sensing value 220, a time during which the magnitude value of acceleration for each direction is measured one time may be set according to a specified length. The electronic device 101 may measure acceleration in a particular space and/or location from the first time Timestamp 1 to the Nth time Timestamp N using an accelerometer included in the sensor module 176. For example, the acceleration sensing value 220 may include an X-axial direction acceleration AccX₁ of the electronic device 101 measured at the first time Timestamp 1, a Y-axial direction acceleration AccY₁ of the electronic device 101 measured at the first time Timestamp 1, and a Z-axial direction acceleration AccZ₁ of the electronic device 101 measured at the first time Timestamp 1. For another example, the acceleration sensing value 220 may include an X-axial direction acceleration AccX_{N} of the electronic device 101 measured at the Nth time Timestamp N, a Y-axial direction acceleration AccY_{N} of the electronic device 101 measured at the Nth time Timestamp N, and a Z-axial direction acceleration AccZ_{N} of the electronic device 101 measured at the Nth time Timestamp N.

In an embodiment, the gyro sensing value 230 may include a value of an angle orientation of the electronic device 101 with respect to a ground and measured in a particular space and/or location according to a specified sampling rate. Regarding the gyro sensing value 230, a time during which the angle orientation value is measured one time may be set according to a specified length. The electronic device 101 may measure the value of the angle orientation formed with the ground in a particular space and/or location at the first time Timestamp 1, a second time Timestamp 2, and a third time Timestamp 3 using a gyroscope included in the sensor module 176. For example, the gyro sensing value 230 may include a roll value Roll₁ of the electronic device 101 measured at the first time Timestamp 1, a measured pitch value Pitch₁ of the electronic device 101, and a measured yaw value Yaw₁ of the electronic device 101. For another example, the gyro sensing value 230 may include a roll value Roll₂ of the electronic device 101 measured at the second time Timestamp 2, a measured pitch value Pitch₂ of the electronic device 101, and a measured yaw value Yaw₁ of the electronic device 101. For another example, the gyro sensing value 230 may include a roll value Roll₃ of the electronic device 101 measured at the third time Timestamp 3, a measured pitch value Pitch₃ of the electronic device 101, and a measured yaw value Yaw₃ of the electronic device 101.

In an embodiment, the first wireless communication signal 240 may be a strength value of an access point (AP) measured by a wireless communication module (e.g., the wireless communication module 192 of FIG. 1). The first wireless communication signal 240 may include information related to the number of AP signals of a wideband LAN (WLAN). The first wireless communication signal 240 may include information related to strength of an AP signal measured in a particular space and/or location. For example, the first wireless communication signal 240 may include a first AP signal strength and a second AP signal strength.

In an embodiment, the second wireless communication signal 250 may be a strength value of a cell signal of cellular communication measured by the wireless communication module 192. The second wireless communication signal 250 may include information related to the number of cells. The second wireless communication signal 250 may include information related to first to Nth cell signal strengths measured in a particular space and/or location. For example, the second wireless communication signal 250 may include a first cell signal strength and an Nth cell signal strength.

In an embodiment, a processor (e.g., the processor 120 of FIG. 1) of the electronic device 101 may include various processing circuitry and determine a radius of a particular space for which the one-dimensional virtual marker 201 is to be generated. The processor 120 may collect sensing values within the radius of the particular space using the sensing module 176 while moving the electronic device 101 within the radius of the particular space.

In an embodiment, the processor 120 of the electronic device 101 may estimate a relative location of the electronic device 101 by performing, for example, and without limitation, image processing in a camera (e.g., the camera 180 of FIG. 1) that supports an augmented reality (AR) technology in order to spatially match a specified space and sensing values.

In an embodiment, the one-dimensional virtual marker 201 may be generated using sensing values, but an embodiment of the present disclosure is not limited thereto, and thus the virtual marker may have a shape of a one-dimensional line, two-dimensional plane, or three-dimensional space.

In an embodiment, the one-dimensional virtual marker 201 may include movement information about the electronic device 101. The movement information may include sensing values which change while the electronic device 101 moves, a speed of the electronic device 101, and/or an orientation of the electronic device 101. The one-dimensional virtual marker 201 may include a feature of a specified space. When the electronic device 101 generates the one-dimensional virtual marker 201 indoors, the one-dimensional virtual marker 201 may reflect a feature related to a shape of an indoor structure and/or a physical characteristic of an object arranged indoors. For example, the one-dimensional virtual marker 201 may reflect a shape of a structure such as indoor steel frames, stairs, and/or walls. For another example, the one-dimensional virtual marker 201 may reflect a material characteristic of an object such as furniture arranged indoors.

In an embodiment, the one-dimensional virtual marker 201 may store magnetic field information that reflects indoor structure information. The one-dimensional virtual marker 201 may store an acceleration value and/or rotary motion information of the electronic device 101. The one-dimensional virtual marker 201 may store surrounding wireless signal information in relation to power consumption optimization. For example, the one-dimensional virtual marker 201 may store Wi-Fi signal information and/or cellular signal information. In the one-dimensional virtual marker 201, the first time Timestamp 1 to the Nth time Timestamp N may be stored as time values set to measure the sensing values 210, 220, 230, 240, and 250 such as magnetic field information every specified period.

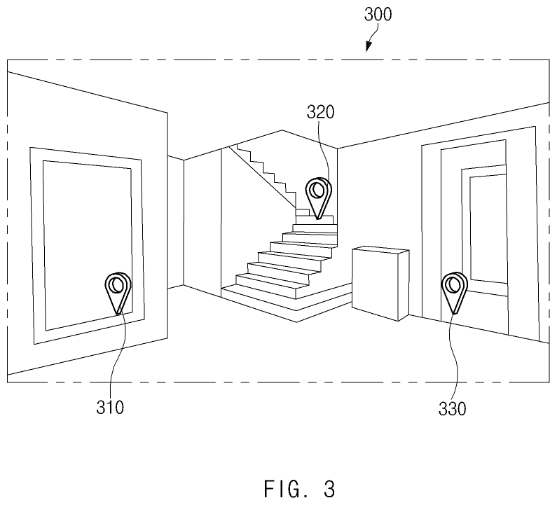

FIG. 3 is a diagram 300 illustrating an example method of setting virtual markers 310, 320, and 330 on particular locations according to an embodiment.

In an embodiment, the virtual markers 310, 320, and 330 may be data corresponding to a particular place. For example, the virtual markers 310, 320, and 330 may be data corresponding to a small region, detailed location, and/or short path in a particular place. The virtual markers 310, 320, and 330 may be stored in a memory (e.g., the memory 130 of FIG. 1) of an electronic device (e.g., the electronic device 101 of FIG. 1). The virtual markers 310, 320, and 330 may include, for example, and without limitation, a magnetic sensing value (e.g., the magnetic sensing value 210 of FIG. 2), an acceleration sensing value (e.g., the acceleration sensing value 220 of FIG. 2), a gyro sensing value (e.g., the gyro sensing value 230 of FIG. 2), a first wireless communication signal (e.g., the first wireless communication signal 240 of FIG. 2), and/or a second wireless communication signal (e.g., the second wireless communication signal 250 of FIG. 2), or the like, of a small region, detailed location, and/or short path.

In an embodiment, the magnetic sensing value 210, the first wireless communication signal 240, and/or the second wireless communication signal 250 of a small region, detailed location, and/or short path included in the virtual markers 310, 320, and 330 may vary according to an indoor structure. For example, the magnetic sensing value 210, the first wireless communication signal 240, and/or the second wireless communication signal 250 may vary according to a frame of a building and/or a material of a structure. For another example, the magnetic sensing value 210, the first wireless communication signal 240, and/or the second wireless communication signal 250 may vary according to a shape and/or material of an object arranged indoors.

In an embodiment, when the virtual markers 310, 320, and 330 correspond to a short path, the short path may have a length of about 30 cm to about 70 cm. The virtual markers 310, 320, and 330 may be data corresponding to an indoor particular place and/or an object arranged indoors. The virtual markers 310, 320, and 330 may include a first virtual marker 310, a second virtual marker 320, and/or a third virtual marker 330 corresponding to an indoor particular place and/or an object arranged indoors. For example, a user may define the first virtual marker 310 as a position in front of a mirror. For another example, the user may define the second virtual marker 320 as a position on stairs. For another example, the user may define the third virtual marker 330 as a position in front of a room door.

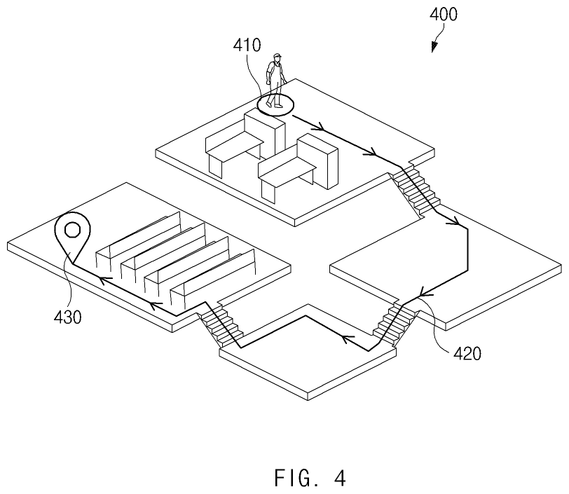

FIG. 4 is a diagram 400 illustrating an example method of setting virtual markers 410, 420, and 430 in a particular path according to an embodiment.

In an embodiment, the virtual markers 410, 420, and 430 may be data corresponding to a particular place. For example, the virtual markers 410, 420, and 430 may be data corresponding to a long path in a particular place. The virtual markers 410, 420, and 430 may be stored in a memory (e.g., the memory 130 of FIG. 1) of an electronic device (e.g., the electronic device 101 of FIG. 1). The virtual markers 410, 420, and 430 may include, for example, and without limitation, a magnetic sensing value (e.g., the magnetic sensing value 210 of FIG. 2), an acceleration sensing value (e.g., the acceleration sensing value 220 of FIG. 2), a gyro sensing value (e.g., the gyro sensing value 230 of FIG. 2), a first wireless communication signal (e.g., the first wireless communication signal 240 of FIG. 2), and/or a second wireless communication signal (e.g., the second wireless communication signal 250 of FIG. 2), or the like, of a long path.

In an embodiment, the magnetic sensing value 210, the acceleration sensing value 220, the gyro sensing value 230, the first wireless communication signal 240, and/or the second wireless communication signal 250 of a long path included in the virtual markers 410, 420, and 430 may vary according to an indoor structure. For example, the magnetic sensing value 210, the first wireless communication signal 240, and/or the second wireless communication signal 250 may vary according to a shape of a path and/or a structure around the path. For another example, the acceleration sensing value 220 and/or the gyro sensing value 230 may vary according to a speed of traveling in a path and/or the orientation of the electronic device 101 when traveling in a path.

In an embodiment, when the virtual markers 410, 420, and 430 correspond to a long path, the long path may have a length of about 5 m to about 20 m. The virtual marker 410 may be data corresponding to an indoor particular traffic line. For example, the virtual markers 410, 420, and 430 may be data corresponding to a traffic line which starts from a first point 410, passes through a second point 420, and reaches a third point 430. The user may define the virtual markers 410, 420, and 430 as data indicating a continuous travel path such as a traffic line which starts from a starting point 410, passes through an internal path 420 of a building, and reaches a destination point 430.

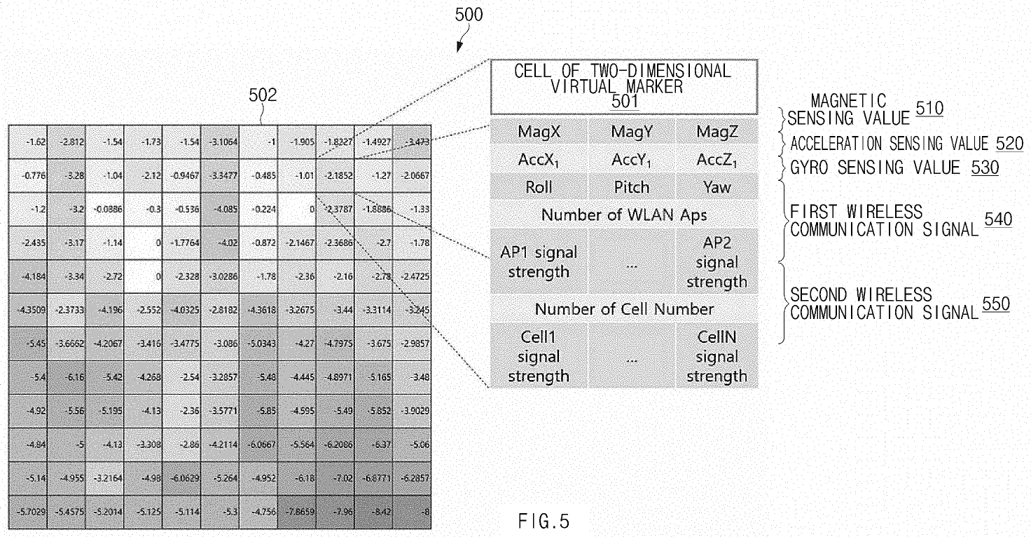

FIG. 5 is a diagram 500 illustrating example sensing values 510, 520, 530, 540, and 550 measured on a two-dimensional plane mapped to a two-dimensional virtual marker 502 according to an embodiment.

In an embodiment, a magnetic sensing value 510, an acceleration sensing value 520, a gyro sensing value 530, a first wireless communication signal 540, and/or a second wireless communication signal 550 may be sensed on a two-dimensional plane. The magnetic sensing value 510, the acceleration sensing value 520, the gyro sensing value 530, the first wireless communication signal 540, and/or the second wireless communication signal 550 may be measured using substantially the same method as that for the magnetic sensing value 210, the acceleration sensing value 220, the gyro sensing value 230, the first wireless communication signal 240, and/or the second wireless communication signal 250 of FIG. 2. The magnetic sensing value 510, the acceleration sensing value 520, the gyro sensing value 530, the first wireless communication signal 540, and/or the second wireless communication signal 550 may be included in a cell 501 of the two-dimensional virtual marker. The cell 501 of the two-dimensional virtual maker may be a unit area obtained by dividing a space in which the two-dimensional virtual marker 502 is defined by a specified size. The two-dimensional virtual marker 502 may be generated by combining, for each space, the cells 501 of the two-dimensional virtual marker.

In an embodiment, a virtual marker is not limited to one dimension, and may be expanded to the two-dimensional virtual marker 502 and/or a three-dimensional virtual marker. In the case of the two-dimensional virtual marker 502, the sensing values 510, 520, 530, 540, and 550 such as magnetic field information measured in each cell 501 of the two-dimensional virtual marker, which is a unit on a plane in a two-dimensional space, may be mapped in this space. For example, a processor (e.g., the processor 120 of FIG. 1) may map the sensing values 510, 520, 530, 540, and 550 to correspond to an indoor structure of a measured space. For another example, the processor 120 may map the sensing values 510, 520, 530, 540, and 550 to correspond to an average value of each cell 501 of the two-dimensional virtual marker according to a measured traffic line length and/or cell size. The processor 120 of the electronic device 101 may generate the two-dimensional virtual marker 502 by mapping the measured sensing values 510, 520, 530, 540, and 550 onto a two-dimensional plane. The two-dimensional virtual marker 502 in which the sensing values 510, 520, 530, 540, and 550 measured on a two-dimensional plane are mapped may be digitized and displayed for each cell within a plane.

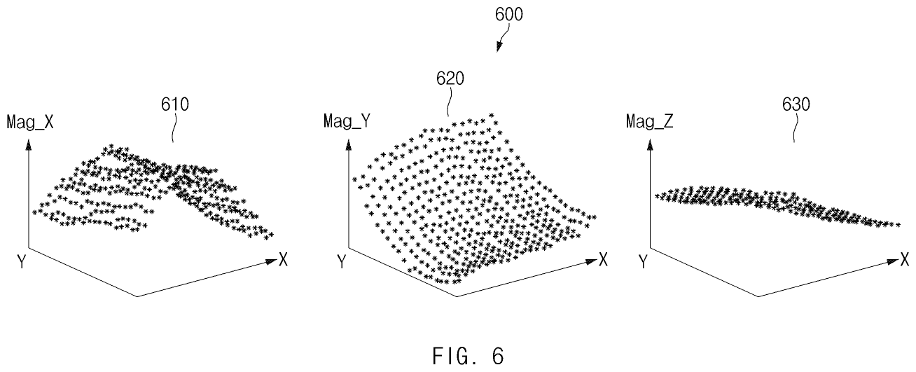

FIG. 6 is a diagram 600 illustrating example imaged data of two-dimensional virtual markers 610, 620, and 630 generated using magnetic field values Mag_X, Mag_Y, and Mag_Z measured by the electronic device 101 according to an embodiment.

As illustrated in FIG. 6, the magnetic field values Mag_X, Mag_Y, and Mag_Z measured in X-axis, Y-axis, and Z-axis directions of the electronic device 101 may have different values according to a location in a two-dimensional space. Therefore, a distinctive pattern may be exhibited for each axis direction for each travel direction as the electronic device 101 travels in a space. A processor (e.g., the processor 120 of FIG. 1) of the electronic device 101 may reduce a possibility of false detection of the two-dimensional virtual markers 610, 620, and 630 by increasing not only precision of detection but also accuracy of detection by comparing all of the values of the three axes, e.g., X, Y, and Z axes.

In an embodiment, the processor 120 of the electronic device 101 may measure an X-axial direction magnetic field strength Mag_X, a Y-axial direction magnetic field strength Mag_Y, and a Z-axial direction magnetic field strength Mag_Z on a two-dimensional plane (XY plane) using the magnetic field sensor of the sensor module 176. A display device (e.g., the display device 160 of FIG. 1) of the electronic device 101 may generate the two-dimensional virtual markers 610, 620, and 630 from the magnetic field values measured by the sensor module 176. The two-dimensional virtual markers 610, 620, and 630, for example, may be used for each of X, Y, and Z axis components. For example, the electronic device 101 may store the two-dimensional virtual markers 610, 620, and 630 in a memory (e.g., the memory 130 of FIG. 1). For another example, the electronic device 101 may image magnetic field values for each of X, Y, and Z axis components in order to confirm the two-dimensional virtual markers 610, 620, and 630.

In the case of using the above-described virtual markers (e.g., the one-dimensional virtual marker 201 of FIG. 2 and/or the two-dimensional virtual marker 502 of FIG. 5), when the electronic device 101 provides a location-based service, the electronic device 101 may provide an indoor location service that does not require additional data such as an indoor map and/or fingerprint map and/or an additional infrastructure such as Bluetooth beacon. The virtual markers 201 and 502 may operate based on a signal measured by the electronic device 101 in an arbitrary indoor location without requiring a preliminary task and/or infrastructure installation. For example, the virtual markers 201 and 502 generated in advance may be stored in a memory (e.g., the memory 130 of FIG. 1). The electronic device 101 may measure a signal using the sensor module 176. For example, the sensor module 176 may measure the magnetic sensing values 210 and 510, the acceleration sensing values 220 and 520, the gyro sensing values 230 and 530, the first wireless communication signals 240 and 540, and/or the second wireless communication signals 250 and 550. For example, the sensing values 210, 220, 230, 240, 250, 510, 520, 530, 540, and 550 may include a cellular signal, a Wi-Fi signal, a magnetic field value, and/or an image captured by the camera 180. A processor (e.g., the processor 120 of FIG. 1) of the electronic device 101 may detect locations corresponding to the virtual markers 201 and 502 by comparing the virtual markers 201 and 502 stored in the memory 130 with a signal measured by the sensor module 176.

The virtual markers 201 and 502 according to an embodiment may reflect a signal characteristic that varies due to a measured signal and/or a particular object arranged indoors by reflecting a feature of an indoor structure while the electronic device 101 is moving within a fixed range during a fixed time in an arbitrary place. The virtual markers 201 and 502 may include movement information related to movement of the electronic device 101. For example, the virtual markers 201 and 502 may be data including coordinate information corresponding to movement of the electronic device 101 and/or a current location of the electronic device 101 relative to a particular space and/or object using the space and/or object as a reference index. The processor 120 may provide a service structure for detecting and/or confirming objects arranged in spaces corresponding to the virtual markers 201 and 502 and/or whether the electronic device enters spaces corresponding to the virtual markers 201 and 502.

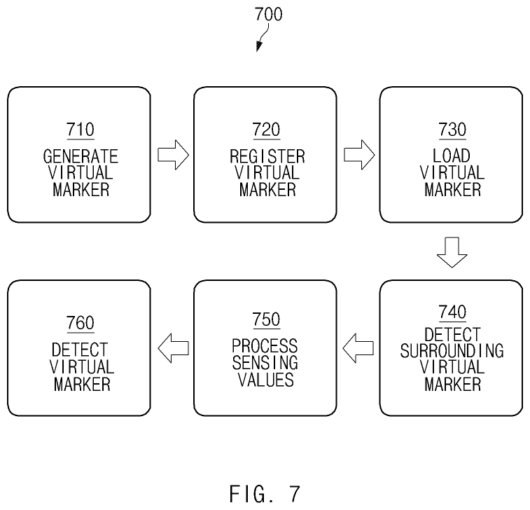

FIG. 7 is a flowchart 700 illustrating an example framework of the virtual markers 201 and 502 according to an embodiment.

In an embodiment, the processor 120 of the electronic device 101 may perform a virtual marker generation operation 710. The processor 120 may generate a first virtual marker corresponding to a first location that is a current location of the electronic device 101 using sensing data including, for example, and without limitation, a magnetic signal, movement of the electronic device, acceleration of the electronic device, and/or an angle orientation of the electronic device formed with the ground.

In an embodiment, when generating the virtual markers 201 and 502, the processor 120 may determine, for example, a radius of a particular space for which the virtual markers 201 and 502 are to be generated. The processor 120 may collect sensing values (e.g., the sensing values 210, 220, 230, 240, and 250 of FIG. 2 and/or the sensing values 510, 520, 530, 540, and 550 of FIG. 5) within the radius through movement of the electronic device 101 within the radius using the sensor module 176. The processor 120 may estimate the first location that is the current location of the electronic device 101 using, for example, the camera 180 that supports an augmented reality technology for spatial matching between a determined space and measured sensing values 210, 220, 230, 240, 250, 510, 520, 530, 540, and 550. The electronic device 101 may identify a feature in an image obtained using the camera 180. For example, when generating virtual markers, the processor 120 of the electronic device 101 may recognize a feature point (e.g., characteristic places (position 310 in front of a mirror, position 320 in front of a door, stairs 330) of FIG. 3, floor pattern, location and shape of arranged furniture, bend in a wall, etc.) at the same time as measurement of sensing values. The processor 120 may execute a process of designating an arbitrary reference point in the obtained image. The processor 120 may estimate a distance traveled by the electronic device 101 based on the reference point. The processor 120 may estimate a traffic line (e.g., the traffic line of FIG. 4 which starts from the starting point 410, passes through the internal path 420 of a building, and reaches the destination point 430) along which the electronic device 101 moves from one point to another point in an indoor place. The processor 120 may measure a degree of movement every specified period. The processor 120 may sort, in a space, sensing values related to the measured degree of movement.

In an embodiment, the processor 120 of the electronic device 101 may perform a virtual marker registration operation 720. The processor 120 may store the first virtual marker in a memory (e.g., the memory 130 of FIG. 1). The first virtual marker stored in the memory 130 may be registered in a virtual marker list in the memory 130.

In an embodiment, the processor 120 of the electronic device 101 may perform a virtual marker loading operation 730. After generating the virtual markers 201 and 502, the processor 120 may store the virtual markers 201 and 502 in the memory 130 and register the same in the virtual marker list. The processor 120 may load the virtual markers 201 and 502 in order to detect the registered virtual markers 201 and 502. For example, the electronic device 101 may load the virtual markers 201 and 502 when an application (e.g., the application 146 of FIG. 1) is executed to perform an event corresponding the registered virtual markers 201 and 502. For another example, the processor 120 may load the virtual markers 201 and 502 when entry within a fixed radius from a location corresponding to the registered virtual markers 201 and 502 is confirmed. For another example, upon receiving a notification about a service related to a location for which the virtual markers 201 and 502 have been registered, the processor 120 may load a virtual marker to be detected from the memory 130 among the virtual markers registered in the virtual marker list.

In an embodiment, the processor 120 of the electronic device 101 may perform a surrounding virtual marker detection operation 740. In order to confirm whether entry to the first location has been performed after registering a virtual marker to be detected, the processor 120 may confirm whether entry within a fixed radius from the first location has been performed.

In an embodiment, in order to confirm whether entry within a fixed radius from the virtual markers 201 and 502 has been performed, the processor 120 may use a wireless communication signal such as a cellular signal and/or Wi-Fi signal which is capable of being received constantly and does not require additional power consumption in order to be transmitted/received. The processor 120 may use the wireless communication circuit 192 to detect whether entry within a fixed radius from the first location has been performed from a relatively wide radius. When it is confirmed that the electronic device 101 has entered within a fixed radius from the first location, the processor 120 may operate at least a portion of sensors of the sensor module 176 used to generate the virtual markers 201 and 502. For example, when the electronic device 101 has entered within a fixed radius from the first location, the processor 120 may operate sensors required for detecting the first virtual marker among the sensors of the sensor module 176.

In an embodiment, the processor 120 of the electronic device 101 may perform a sensing value processing operation 750. The processor 120 may measure the sensing values 210, 220, 230, 240, 250, 510, 520, 530, 540, and 550 using the sensor module 176 within a fixed radius.

In an embodiment, the processor 120 may correct errors of the sensing values 210, 220, 230, 240, 250, 510, 520, 530, 540, and 550 which may occur due to movement of the electronic device 101. The processor 120 may sort and compare information included when generating the virtual markers 201 and 502 and information measured when detecting the virtual markers 201 and 502 in order to correct errors of the sensing values 210, 220, 230, 240, 250, 510, 520, 530, 540, and 550 that have changed due to movement of the electronic device 101.

In an embodiment, the processor 120 of the electronic device 101 may perform a virtual marker detection operation 760. The processor 120 may confirm whether entry to the first location has been performed by comparing measured sensing values with sensing data of the first virtual marker. The processor 120 may compare the sensing values 210, 220, 230, 240, 250, 510, 520, 530, 540, and 550 corrected after being measured in real time with sensing data of the generated virtual markers 201 and 502, and may provide a specified service when the sensing values match the sensing data. For example, the processor 120 may be configured to perform an event designated to be performed in the first location by the electronic device 101 or request a specified service when an arbitrary virtual marker matches the first virtual marker.

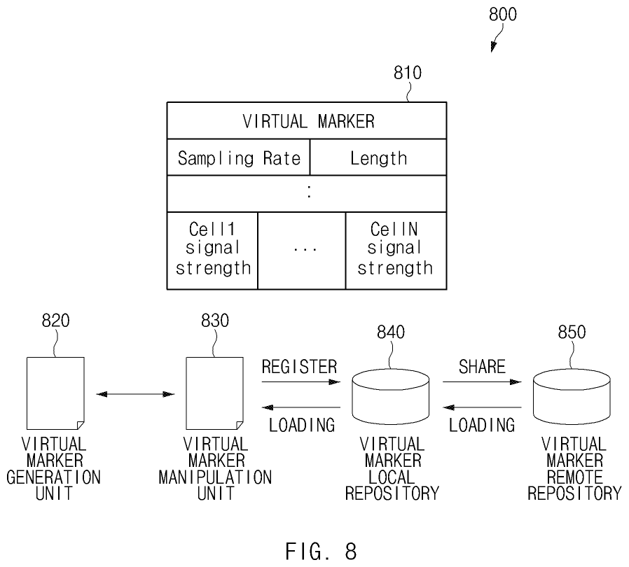

FIG. 8 is a diagram 800 illustrating an example operation of registering, storing, and/or loading a virtual marker 810 according to an embodiment.

In an embodiment, the processor 120 of the electronic device 101 may generate, register, store, and/or load the virtual marker 810. The processor 120 may include a virtual marker generation unit (e.g., including processing circuitry and/or executable program elements) 820 and a virtual marker manipulation unit (e.g., including processing circuitry and/or executable program elements) 830. The virtual marker generation unit 820 may perform the virtual marker generation operation 710. The virtual marker manipulation unit 830 may perform the virtual marker registration operation 720 and perform the virtual marker loading operation 730. The memory 130 may include a virtual marker local repository 840. For example, the virtual marker local repository 840 may be a storage space included in the memory 130 of the electronic device 101. The electronic device 101 may be connected to a virtual marker remote repository 850. The virtual marker remote repository 850 may, for example, be a server (e.g., the server 103 of FIG. 1) connected to a wireless communication module (e.g., the wireless communication module 192 of FIG. 1) of the electronic device 101.

In an embodiment, the processor 120 may register and/or store the generated virtual marker 810 in the virtual marker list. The virtual marker list may be present in the virtual marker local repository 840 and/or the virtual marker remote repository 850.

In an embodiment, the processor 120 may load the virtual marker 810 registered and/or stored in the virtual marker list. The processor 810 may load the virtual marker 810 from the virtual marker local repository 840 and/or the virtual marker remote repository 850.

In an embodiment, the virtual marker local repository 840 may transmit the virtual marker 810 to the virtual marker remote repository 850. The virtual marker remote repository 850 may store the transmitted virtual marker 810. The virtual marker 810 stored in the virtual marker remote repository may be shared with an external electronic device. The virtual marker remote repository 850 may perform first sharing for sharing the registered and/or stored virtual marker 810 with an external electronic device.

In an embodiment, the processor 120 may download a virtual marker registered by an external electronic device and stored in the virtual marker remote repository 850. The processor 120 may perform second sharing for sharing a virtual marker registered by an external electronic device.

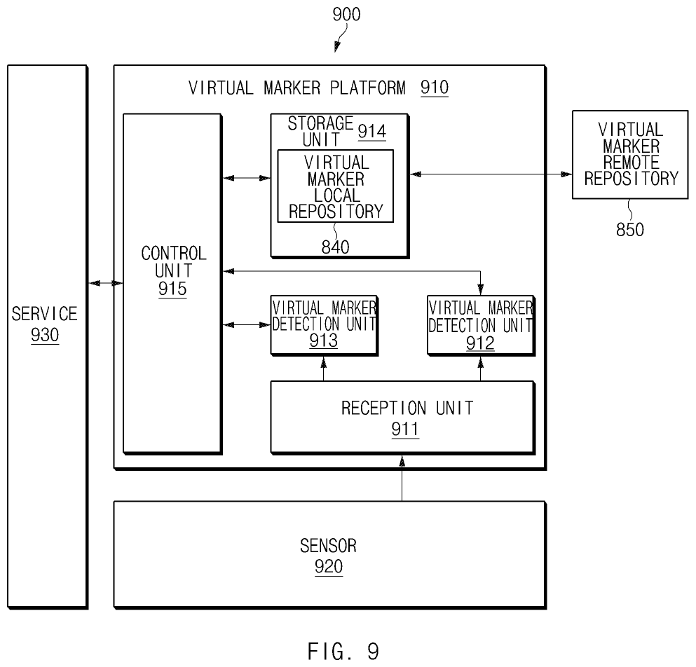

FIG. 9 is a block diagram 900 illustrating an example virtual marker platform 910 according to an embodiment.

The virtual marker platform 910 may be stored in a memory (e.g., the memory 130 of FIG. 1). The virtual marker platform 910 may include one or more instructions. A processor (e.g., the processor 120 of FIG. 1) may load the virtual marker platform 910 from the memory 130 and may execute the virtual marker platform 910. The virtual marker platform 910 according to an embodiment may include a reception unit (e.g., including reception circuitry) 911, a virtual marker generation unit (e.g., including generating circuitry) 912, a virtual marker detection unit (e.g., including detecting circuitry) 913, a storage unit 914, and a control unit (e.g., including control or processing circuitry) 915.

According to an embodiment, the reception unit 911 may include various circuitry and receive sensing data from a sensor 920. The sensing data may include, for example, and without limitation, a magnetic signal, movement of an electronic device (e.g., the electronic device 101 of FIG. 1), acceleration of the electronic device 101, and/or an angle orientation, or the like, of the electronic device 101 with respect to the ground.

In an embodiment, the reception unit 911 may collect and provide the sensing data to the virtual marker generation unit 912 and/or the virtual marker detection unit 913. The reception unit 911 may collect data from the sensor 920 including a magnetic field sensor, an accelerometer, and/or a gyro sensor.

In an embodiment, the reception unit 911 may correct the sensing data using movement information about the electronic device 101 to use the sensing data in generating and/or detecting a virtual marker (e.g., the virtual marker 810). The reception unit 911 may generate information such as the orientation and/or posture of the electronic device 101 from the collected sensing data and provide the generated information to the virtual marker generation unit 912 and/or the virtual marker detection unit 913 in order to provide essential information and/or efficient information for generating and/or detecting the virtual marker 810.

In an embodiment, the virtual marker generation unit 912 may include various circuitry and generate the first virtual marker corresponding to the first location that is the current location of the electronic device 101 using the sensing data. The virtual marker generation unit 912 may receive, from the control unit 915, a request for generating the virtual marker 810. The virtual marker generation unit 912 may generate the first virtual marker according to a specified format based on the sensing data such as magnetic field information provided from the reception unit 911, movement information about the electronic device 101, and/or an image captured by the camera 180 that supports augmented reality. The virtual marker generation unit 912 may request the control unit 915 to register the generated virtual marker 810.

In an embodiment, the virtual marker detection unit 913 may include various circuitry and detect an arbitrary virtual marker. The virtual marker detection unit 913 may detect the virtual marker 810 corresponding to the virtual marker 810 requested from the control unit 915. When the virtual marker 810 requested from the control unit 915 is detected, the virtual marker detection unit 913 may transfer a result related to the detected virtual marker 810 to the control unit 915.

In an embodiment, the storage unit 914 may store the first virtual marker. The storage unit 914 may include the virtual marker local repository 840. The virtual marker local repository 840 may be a partial physical or logical region of the memory 130. For example, the virtual marker local repository 840 may be a physically allocated partial region of a memory or may be defined as a logical memory address value. The virtual marker remote repository 850 may be a server (e.g., the server 103 of FIG. 1) outside the electronic device 101.

In an embodiment, the control unit 915 may include various processing or control circuitry and register the virtual marker 810 by requesting the virtual marker local repository 840 and/or the virtual marker remote repository 850 to register the virtual marker 840. The control unit 915 may load a stored virtual marker list and/or stored virtual marker by transmitting, to the virtual marker local repository 840 and/or the virtual marker remote repository 850, a request for loading the stored virtual marker list and/or stored virtual marker.

In an embodiment, the virtual marker 810 may be registered in the virtual marker local repository 840 and/or the virtual marker remote repository 850 according to whether to use the virtual marker 810 only in the electronic device 101 that has generated the virtual marker 810 or also in an external electronic device. The virtual marker 810 may be required to be registered in the virtual marker remote repository 850 in order to use the virtual marker 810 also in an external electronic device.

In an embodiment, the control unit 915 may register the first virtual marker, may detect an arbitrary virtual marker, and may load the first virtual marker from the storage unit 914. The control unit 915 may control signals and/or pieces of information transmitted/received in the virtual marker platform 910.

In an embodiment, a service 930 may include, for example, a function related to detection of the virtual marker 810 in the electronic device 101. The service 930 may include an application (e.g., the application 146) executed in a location in which the virtual marker 810 is detected or a function (or operation) provided by the application 146. For example, the service 930 may include a fitness application configured to be executed at an entrance to a fitness center in which the electronic device 101 detects the virtual marker 810. The service 930 may include a notification for notifying an event that occurs in a location in which the virtual marker 810 is detected. For example, the service 930 may notify, through a push notification, that the electronic device 101 has entered an entrance to a mart. The service 930 may include a function of performing authentication or changing operation of the application 146 as the virtual marker 810 is detected. For example, when the electronic device 101 arrives at a checkout, the service 930 may change a state of a payment application into a payment-ready state and may display an indication for guiding the user to perform authentication.

In an embodiment, the control unit 915 may provide the service 930 mapped to a location in which the virtual marker 810 is detected. For example, the control unit 915 may execute the service 930 when it is detected that the electronic device 101 enters a location in which the virtual marker 810 has been generated. For another example, the control unit 915 may transmit, to the service 930, a control signal for requesting execution of a specified event when it is detected that the electronic device 101 enters a location in which the virtual marker 810 has been generated.

In an embodiment, the virtual marker platform 910 may not include at least one of the components illustrated in FIG. 9, may include another component not shown, or may include a combination of a plurality of components. For example, the storage unit 914 may be a component separated from the virtual marker platform 910.

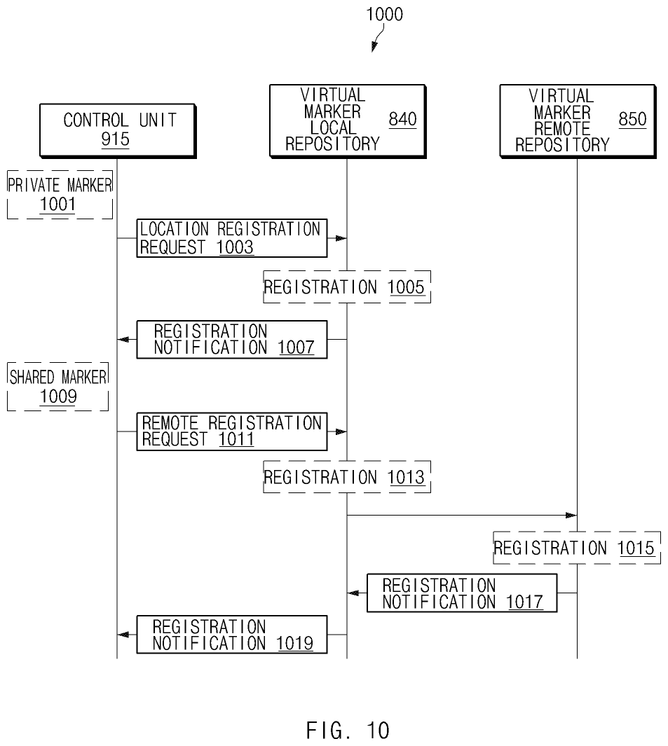

FIG. 10 is a signal flow diagram 1000 illustrating an example process of registering virtual markers 1001 and 1009 according to an embodiment.

In operation 1003, the control unit 915 according to an embodiment may request the virtual marker local repository 840 to locally register a private marker 1001. In operation 1005, the virtual marker local repository 840 may register the private marker 1001. In operation 1007, the virtual marker local repository 840 may notify the control unit 915 of registration of the private marker 1001.

In operation 1011, the control unit 915 according to an embodiment may request the virtual marker local repository 840 to remotely register a shared marker 1009. In operation 1013, the virtual marker local repository 840 may register the shared marker 1009. The virtual marker local repository 840 may transfer the shared marker 1009 to the virtual marker remote repository 850. In operation 1015, the virtual marker remote repository 850 may register the shared marker 1009. In operation 1017, the virtual marker remote repository 850 may notify the virtual marker local repository unit 840 of registration of the shared marker 1009. In operation 1019, the virtual marker local repository 840 may notify the control unit 915 of registration of the shared marker 1009.

In an embodiment, the private marker 1001 and the shared marker 1009 may include the same data. The private marker 1001 and the shared marker 1009 may be differentiated according to whether the markers are determined to be shared with another electronic device. The shared marker 1009 may be data that is capable of being shared with another electronic device or determined to be shared with another electronic device. The shared marker 1009 may be registered in the virtual marker remote repository 850 to be shared with another electronic device.

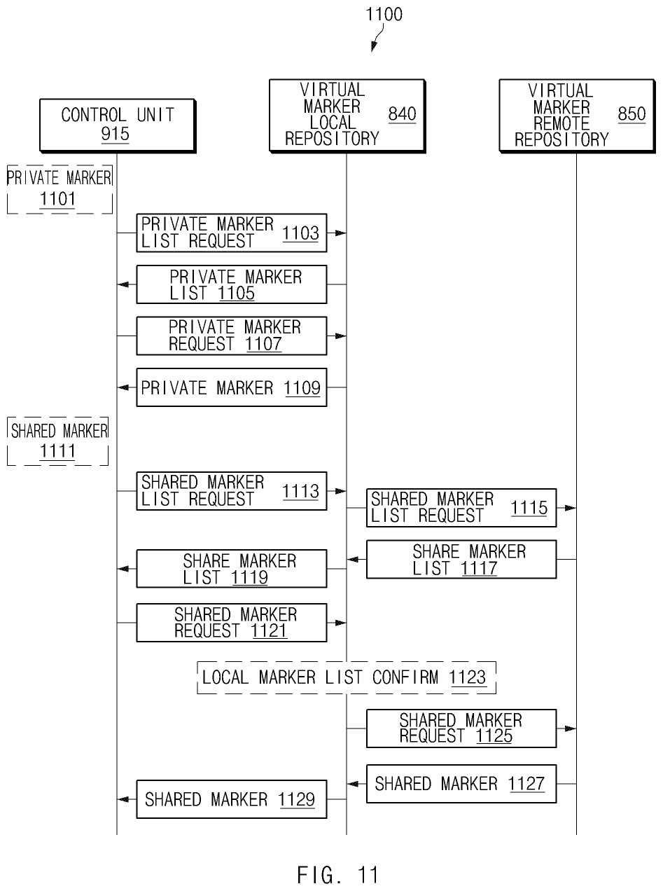

FIG. 11 is a signal flow diagram 1100 illustrating an example process of loading virtual markers 1101 and 1111 according to an embodiment.

The virtual markers 1101 and 1111 according to an embodiment may include a private marker 1101 and a shared marker 1111. The private marker 1101 and the shared marker 1111 of FIG. 11 may be substantially the same as or similar to the private marker 1001 and 1009 of FIG. 10.

In operation 1103, the control unit 915 according to an embodiment may request a private marker list from the virtual marker local repository 840. In operation 1105, the virtual marker local repository 840 may transfer the private marker list to the control unit 915. The control unit 915 may confirm whether the private marker 1101 is included in the private marker list of the virtual marker local repository 840. In operation 1107, the control unit 915 may request a private marker from the virtual marker local repository 840. In operation 1109, the virtual marker local repository 840 may transfer the private marker to the control unit 915. The control unit 915 may confirm whether the private marker 1101 matches the private marker stored in the virtual marker local repository 840.

In operation 1113, the control unit 915 according to an embodiment may request a shared marker list from the virtual marker local repository 840. In operation 1115, the virtual marker local repository 840 may request the shared marker list from the virtual marker remote repository 850. In operation 1117, the virtual marker remote repository 850 may transfer the shared marker list to the virtual marker local repository 840. In operation 1119, the virtual marker local repository 840 may transfer the shared marker list to the control unit 915. The control unit 915 may confirm whether the shared marker 1111 is included in the shared marker list of the virtual marker remote repository 850.

In operation 1121, the control unit 915 according to an embodiment may request a shared marker from the virtual marker local repository 840. In operation 1123, the virtual marker local repository 840 may confirm a local marker list. The virtual marker local repository 840 may confirm that there is no shared marker in the local marker list, and in operation 1125 may transfer a shared marker request to the virtual marker remote repository 850. In operation 1127, the virtual marker remote repository 850 may transfer a shared marker to the virtual marker local repository 840. In operation 1129, the virtual marker local repository 840 may transfer the shared marker to the control unit 915. The control unit 915 may confirm whether the shared marker 1111 matches the shared marker stored in the virtual marker remote repository 850.

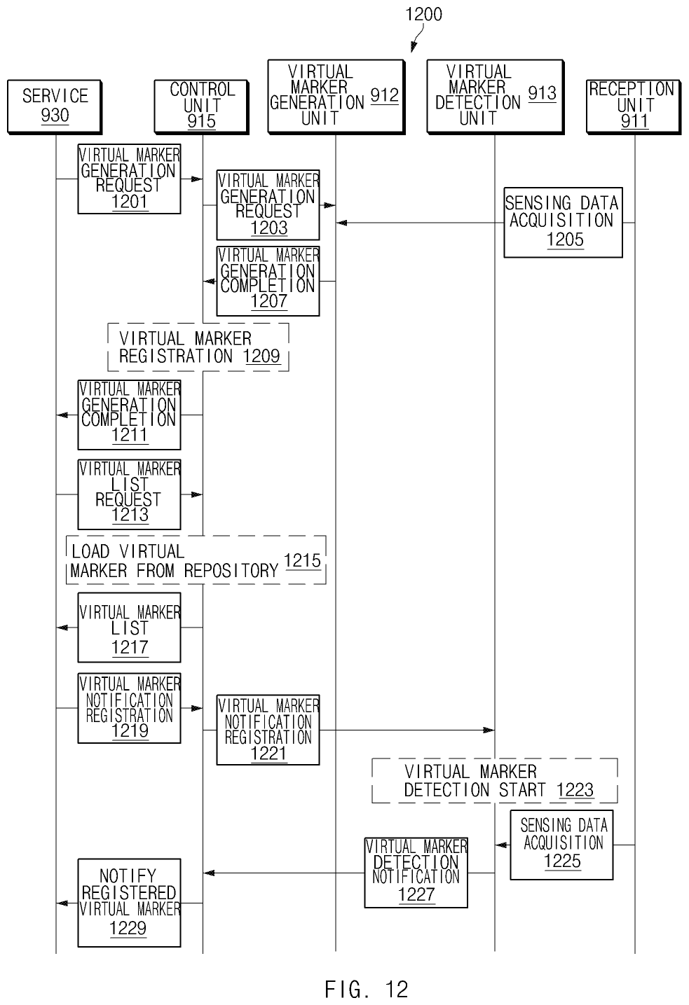

FIG. 12 is a diagram 1200 illustrating an example operation in which a virtual marker platform (e.g., the virtual marker platform 910 of FIG. 9) detects a virtual marker (e.g., the virtual marker 810 of FIG. 8) according to an embodiment.

In an embodiment, in operation 1201, the service 930 may request the control unit 915 to generate the virtual marker 810. In operation 1203, the control unit 915 may request the virtual marker generation unit 912 to generate the virtual marker 810.

In an embodiment, in operation 1205, the reception unit 911 may obtain and transfer sensing data to the virtual marker generation unit 912. The virtual marker generation unit 912 may generate the virtual marker 810. For example, the virtual marker generation unit 912 may generate the first virtual marker indicating the current location of an electronic device (e.g., the electronic device 101 of FIG. 1). In operation 1207, the virtual marker generation unit 912 may notify the control unit 915 of completion of generation of the virtual marker 810. In operation 1209, the control unit 915 may register the virtual marker 810 in a storage unit (e.g., the storage unit 914 of FIG. 9). In operation 1211, the control unit 915 may notify the service 930 of completion of generation of the virtual marker 810.

In an embodiment, in operation 1213, the service 930 may request a virtual marker list from the control unit 915. In operation 1215, the control unit 915 may load the virtual marker 810 from a repository (e.g., the virtual marker local repository 840 and/or the virtual marker remote repository 850 of FIG. 8). In operation 1217, the control unit 915 may transfer the virtual marker list to the service 930.

In an embodiment, in operation 1219, the service 930 may request the control unit 915 to register a virtual marker notification. The virtual marker notification may include information for requesting a virtual marker platform (e.g., the virtual marker platform 910 of FIG. 9) to start to detect a virtual marker. In operation 1221, the control unit 915 may transfer virtual marker notification registration to the virtual marker detection unit 913. In operation 1223, the virtual marker detection unit 913 may start to detect a virtual marker. In operation 1225, the reception unit 911 may obtain and transfer sensing data to the virtual marker detection unit 913. When the obtained sensing data corresponds to a virtual marker registered in the virtual marker list, the virtual marker detection unit 913 may notify the control unit 915 of detection of the virtual marker in operation 1227. In operation 1229, the control unit 915 may notify the service 930 of a registered virtual marker. For example, the control unit 915 may notify that the electronic device 101 has entered the first location corresponding to the first virtual marker that is the registered virtual marker.

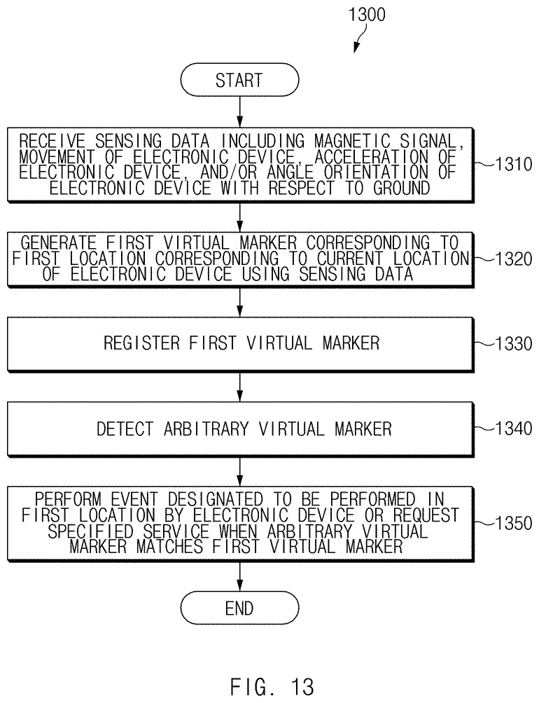

FIG. 13 is a flowchart illustrating an example operation in which an electronic device (e.g., the electronic device 101 of FIG. 1) generates a first virtual marker and detects a virtual marker to perform a specified event or request a specified service according to an embodiment.

In operation 1310, the processor 120 of the electronic device according to an embodiment may receive sensing data including a magnetic signal, movement of the electronic device, acceleration of the electronic device, and/or an angle orientation of the electronic device with respect to ground.

For example, a service (e.g., the service 930 of FIG. 9) may request a control unit (e.g., the control unit 915 of FIG. 9) to generate a virtual marker for a particular space such as a position in front of a front door and/or a position in front of a refrigerator. The control unit 915 may request a virtual marker generation unit (e.g., the virtual marker generation unit 912 of FIG. 9) to generate a virtual marker.

In operation 1320, the processor 120 of the electronic device 101 according to an embodiment may generate the first virtual marker corresponding to the first location corresponding to the current location of the electronic device 101 using the sensing data. The virtual marker generation unit 912 may request the control unit 915 to register the first virtual marker.

In operation 1330, the processor 120 of the electronic device 101 according to an embodiment may register the first virtual marker. The control unit 915 may request a notification about the registered first virtual marker when the service 930 makes the request.

For example, the first virtual marker may be registered to perform a particular service such as a notification in a reminder application and/or a particular operation in, for example, a Bixby routine. The service 930 may request the electronic device 101 to perform a specified operation when entering a corresponding place.

In operation 1340, the processor 120 of the electronic device 101 according to an embodiment may detect an arbitrary virtual marker.

For example, the control unit 915 that has received a notification request from the service 930 may control the virtual marker detection unit 913 to detect the corresponding virtual marker. The virtual marker detection unit 913 may determine whether the electronic device 101 has entered the first location based on the sensing data received from a reception unit (e.g., the reception unit 911 of FIG. 9).

In operation 1350, the processor 120 of the electronic device 101 according to an embodiment may perform an event designated to be performed in the first location by the electronic device 101 or request a specified service when the arbitrary virtual marker matches the first virtual marker. When the first virtual maker is detected, the virtual marker detection unit 913 may notify this detection to the control unit 915. The control unit 915 may perform a specified operation or may notify the service 930 of detection of the first virtual marker.

The descriptions given above with reference to FIG. 13 refer, by way of example, to a case of performing a notification event, such as, for example, a reminder and/or Bixby routine, in response to entry to the first location. However, an embodiment is not limited to this case, and thus a specified event may be performed by recognizing an object using a virtual marker (e.g., the virtual marker 810 of FIG. 8).

In an embodiment, a particular location in a vehicle, such as a car audio system, may be registered as the virtual marker 810. When the electronic device 101 is positioned in a location for which the virtual marker 810 has been registered, a particular application such as a navigation application or a music application may be executed.

In an embodiment, when the service 930 requests that the virtual marker 810 recognizes a particular space and recognizes a particular object, a process of generating the virtual marker 810 in a virtual marker platform (e.g., the virtual marker platform 910 of FIG. 9) and the format of the generated virtual marker may be changed. For example, when the service 930 requests that the virtual marker 810 recognizes a particular space, the control unit 915 may request a reception unit (e.g., the reception unit 911 of FIG. 9) to collect, as much as possible, information about locations through which the electronic device 101 may pass when generating the virtual marker 810. For another example, when the service 930 requests that the virtual marker 810 recognizes a particular object, the control unit 915 may request the reception unit 911 to collect information in a form surrounding the particular object when generating the virtual marker 810.

In an embodiment, when the service 930 makes a request for recognition of a particular space during a process of detecting the virtual marker 810, the control unit 915 may request the virtual marker detection unit 913 to detect whether the electronic device 101 passes through the particular space while moving. When the service 930 makes a request for recognition of a particular object during a process of detecting the virtual marker 810, the control unit 915 may request the virtual marker detection unit 913 to detect a user's intentional act of bringing the electronic device 101 in contact with a periphery of the particular object.

In an embodiment, various services (e.g., the service 930 of FIG. 9) such as an advertisement in a mart may be implemented using a virtual marker platform (e.g., the virtual marker platform 910 of FIG. 9). For example, a position in front of a particular item display shelf in a mart may be registered as a virtual marker (e.g., the virtual marker 810 of FIG. 8). When an arbitrary electronic device enters a location for which the virtual marker 810 is registered, the service 930 may notify information about the corresponding item or related marketing information to a user of the arbitrary electronic device.

In an embodiment, the service 930 may request a control unit (e.g., the control unit 915 of FIG. 9) to generate a shared marker (e.g., the shared marker 1009 of FIG. 10) in advance. In response to the request, the control unit 915 may allow a virtual marker generation unit (e.g., the virtual marker generation unit 912 of FIG. 9) to generate the shared marker 1009. The control unit 915 may register the generated shared marker 1009 in a virtual marker remote repository (e.g., the virtual marker remote repository 850 of FIG. 8).

In an embodiment, the arbitrary electronic device may download the shared marker 1009. The arbitrary electronic device may register a virtual marker list so that the shared marker 1009 may be detected by the virtual marker detection unit 913. When the arbitrary electronic device detects the shared marker 1009, the arbitrary electronic device may receive a notification indicating that the arbitrary electronic device has entered a location for which the shared marker 1009 is set. As described above, the shared marker 1009 generated by an electronic device (e.g., the electronic device 101 of FIG. 1) may be shared to be detected by an arbitrary electronic device.

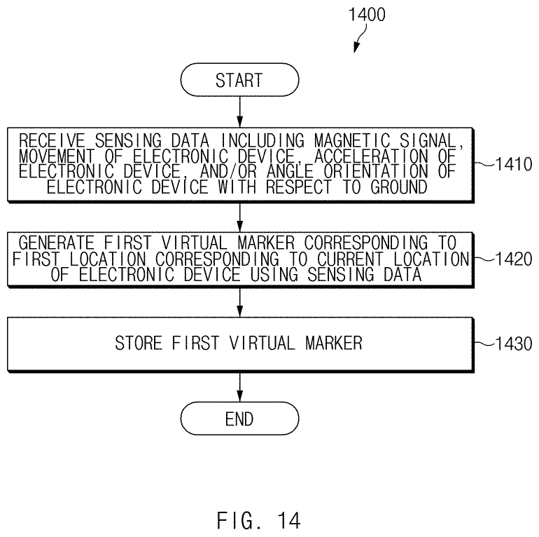

FIG. 14 is a flowchart 1400 illustrating an example operation in which an electronic device (e.g., the electronic device 101 of FIG. 1) receives sensing data and generates and stores a first virtual marker (e.g., the virtual marker 810 of FIG. 8) according to an embodiment.

In operation 1410, the processor 120 of the electronic device 101 according to an embodiment may receive sensing data including a magnetic signal, movement of the electronic device 101, acceleration of the electronic device 101, and/or an angle orientation of the electronic device 101 with respect to ground.

In operation 1420, the processor 120 of the electronic device 101 according to an embodiment may generate a first virtual marker 810 corresponding to the first location corresponding to the current location of the electronic device 101 using the sensing data.

In operation 1430, the processor 120 of the electronic device 101 according to an embodiment may store the first virtual marker 810. The processor 120 may store the generated first virtual marker 810 in a memory (e.g., the memory 130 of FIG. 1) and/or a storage unit (e.g., the storage unit 914 of FIG. 9).

An electronic device (e.g., the electronic device 101 of FIG. 1) according to various example embodiments may include a sensor module (e.g., the sensor module 176 of FIG. 1) comprising at least one sensor configured to detect sensing data including a magnetic signal, movement of the electronic device, acceleration of the electronic device, and/or an angle orientation of the electronic device with respect a ground, a memory (e.g., the memory 130 of FIG. 1) configured to store a virtual marker platform (e.g., the virtual marker platform 910 of FIG. 9), and a processor (e.g., the processor 120 of FIG. 1) operatively connected to the sensor module and the memory, wherein the processor may be configured to control the electronic device to: receive the sensing data from the sensor module, generate a first virtual marker corresponding to a first location corresponding to a current location of the electronic device using the sensing data, store the first virtual marker in the memory, detect an arbitrary virtual marker, load the first virtual marker from the memory, and request a specified service and/or perform an event designated to be performed in the first location by the electronic device based on the arbitrary virtual marker matching the first virtual marker.

In an example embodiment, the sensing data may include a feature caused by an object arranged in an indoor space and/or a structure of the indoor space using the magnetic signal measured while the electronic device 101 is moving within a fixed range during a fixed time in the indoor space.

In an example embodiment, the sensing data may include a magnetic field value (e.g., the magnetic sensing value 210 of FIG. 2), a Wi-Fi value (e.g., the first wireless communication signal 240 of FIG. 2), a cellular value (e.g., the second wireless communication signal 250 of FIG. 2), and/or an image captured by a camera (e.g., the camera module 180 of FIG. 1) of the electronic device.

In an example embodiment, the processor may be configured to generate the first virtual marker for identifying a particular space and/or an object arranged in the particular space using the sensing data.

In an example embodiment, the processor may be configured to map the sensing data to a particular space and/or an object arranged in the particular space using an augmented reality technology based on storing the first virtual marker.

In an example embodiment, the sensing data may include sensing values (e.g., the acceleration sensing value 220 and/or the gyro sensing value 230 of FIG. 2) of an accelerometer and/or a gyro sensor included in the sensor module based on the electronic device moving and/or movement information about the electronic device based on the sensing values.

In an embodiment, the memory may include a virtual marker local repository (e.g., the virtual marker local repository 840 of FIG. 8), and the processor may be configured to perform first sharing for registering the first virtual marker as a shared virtual marker (e.g., the shared marker 1009 of FIG. 10) and sharing the first virtual marker with an external electronic device and second sharing for sharing a second virtual marker generated in the external electronic device and registered as the shared virtual marker, and the storage unit may be configured to register the first virtual marker in the virtual marker local repository and/or a server (e.g., the server 103 of FIG. 1) outside the electronic device to perform the first sharing and/or the second sharing.

In an example embodiment, the first virtual marker may include one-dimensional, two-dimensional, and/or three-dimensional information and information about a speed at which the electronic device passes through a space.

In an example embodiment, the processor may be configured to perform the designated event in a virtual marker list stored in the memory and/or may be configured to load the first virtual marker for requesting the specified service based on the arbitrary virtual marker matching the first virtual marker.

In an example embodiment, based on the electronic device being within a fixed radius from the first location, the processor may be configured to turn on the sensor module, and may be configured to store a feature of the first location and/or an object arranged in the first location to detect entry to the first location or approach to the object.

In an example embodiment, the processor may be configured to sort and/or correct errors of sensing values due to rotation and/or movement of the electronic device measured from the arbitrary virtual marker to compare with the first virtual marker.

A method for detecting a virtual marker (e.g., the virtual marker 201 of FIG. 2 and/or the virtual marker 502 of FIG. 5) corresponding to a location of the electronic device according to various example embodiments may include: generating a first virtual marker corresponding to a first location that is a current location of the electronic device using sensing data including a magnetic signal, movement of the electronic device, acceleration of the electronic device, and/or an angle orientation of the electronic device with respect to a ground, storing the first virtual marker, loading a virtual marker list including the registered first virtual marker, confirming whether the electronic device is within a fixed radius from the first location, measuring a sensing value within the fixed radius from the first location, and confirming whether the electronic device has entered the first location by comparing the sensing value with the first virtual marker.

In an example embodiment, the measuring of the sensing value may include correcting an error due to rotation and/or movement of the electronic device.

In an example embodiment, the method may further include performing an event designated to be performed in the first location by the electronic device and/or requesting a specified service based on the electronic device entering the first location.

According to various example embodiments of the present disclosure, an electronic device may generate a virtual marker in a location corresponding to a location of the electronic device in an indoor place by defining a virtual marker of a corresponding space based on a signal characteristic that reflects a feature of an indoor building structure.

According to various example embodiments of the present disclosure, since an electronic device does not require an additional indoor map and/or a fingerprint map, the amount of transmitted/received data and the latency may be reduced.

According to various example embodiments of the present disclosure, an electronic device does not require installation of additional infrastructure such as Bluetooth beacon when generating and/or detecting a virtual marker, and thus indoor location measurement services may be spread with ease.

According to various example embodiments of the present disclosure, a virtual marker may be, rather than simple location coordinates, an object having the same spatial signal characteristic, and thus an electronic device may specify an object through a search.

The electronic device according to various embodiments may be one of various types of electronic devices. The electronic devices may include, for example, and without limitation, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by one of ordinary skill in the art that various changes in form and detail may be made without departing from the true spirit and full scope of the disclosure, including the appended claims and their equivalents.

What is claimed is:

1. An electronic device comprising:
a sensor module comprising at least one sensor configured to detect sensing data including a magnetic signal, movement of the electronic device, acceleration of the electronic device, and/or an angle orientation of the electronic device with respect to a ground;
a memory configured to store a virtual marker platform; and
a processor operatively connected to the sensor module and the memory,
wherein the processor is configured to control the electronic device to:
receive the sensing data from the sensor module;
generate a first virtual marker corresponding to a first location corresponding to a current location of the electronic device using the sensing data;
store the first virtual marker in the memory;
detect an arbitrary virtual marker;
load the first virtual marker from the memory; and
request a specified service and/or perform an event designated to be performed in the first location by the electronic device based on the arbitrary virtual marker matching the first virtual marker.

2. The electronic device of claim 1, wherein the sensing data comprises a feature caused by an object arranged in an indoor space and/or a structure of the indoor space using the magnetic signal measured based on the electronic device moving within a fixed range during a fixed time in the indoor space.

3. The electronic device of claim 1, wherein the sensing data comprises a magnetic field value, a Wi-Fi value, a cellular value, and/or an image captured by a camera of the electronic device.

4. The electronic device of claim 1, wherein the processor is configured to generate the first virtual marker for identifying a particular space and/or an object arranged in the particular space using the sensing data.

5. The electronic device of claim 1, wherein the processor is configured to map the sensing data to a particular space and/or an object arranged in the particular space using an augmented reality (AR) technology based on storing the first virtual marker.

6. The electronic device of claim 1, wherein the sensing data comprises sensing values of an accelerometer and/or a gyro sensor included in the sensor module based on the electronic device moving and/or movement information about the electronic device based on the sensing values.

7. The electronic device of claim 1,
wherein the memory comprises a virtual marker local repository,
wherein the processor is configured to perform first sharing to register the first virtual marker as a shared virtual marker and sharing the first virtual marker with an external electronic device and to perform second sharing to share a second virtual marker generated in the external electronic device and registered as the shared virtual marker, and
wherein the memory is configured to register the first virtual marker in the virtual marker local repository and/or a server outside the electronic device to perform the first sharing and/or the second sharing.

8. The electronic device of claim 1, wherein the first virtual marker comprises one-dimensional, two-dimensional, and/or three-dimensional information and information about a speed at which the electronic device passes through a space.

9. The electronic device of claim 1, wherein the processor is configured to perform the designated event in a virtual marker list stored in the memory or to load the first virtual marker for requesting the specified service based on the arbitrary virtual marker matching the first virtual marker.

10. The electronic device of claim 1, wherein, based on the electronic device being within a fixed radius from the first location, the processor is configure to turn on the sensor module, and to store a feature of the first location and/or an object arranged in the first location to detect entry to the first location and/or approach to the object.

11. The electronic device of claim 1, wherein the processor is configured to sort and/or correct errors of sensing values due to rotation and/or movement of the electronic device measured from the arbitrary virtual marker to compare with the first virtual marker.

12. A method for detecting a virtual marker corresponding to a location of an electronic device, the method comprising:
receiving sensing data including a magnetic signal, movement of the electronic device, acceleration of the electronic device, and/or an angle orientation of the electronic device with respect to a ground;
generating a first virtual marker corresponding to a first location corresponding to a current location of the electronic device using the sensing data; and
storing the first virtual marker.

13. The method of claim 12, further comprising:
loading a virtual marker list including the stored first virtual marker;
confirming whether the electronic device is within a fixed radius from the first location;
measuring a sensing value within the fixed radius from the first location; and
confirming whether the electronic device has entered the first location by comparing the sensing value with the first virtual marker.

14. The method of claim 13, wherein the measuring of the sensing value comprises correcting an error due to rotation and/or movement of the electronic device.

15. The method of claim 13, further comprising performing an event designated to be performed in the first location by the electronic device and/or requesting a specified service based on the electronic device entering the first location.

16. The method of claim 12, wherein the sensing data comprises a feature caused by an object arranged in an indoor space and/or a structure of the indoor space using the magnetic signal measured based on the electronic device moving within a fixed range during a fixed time in the indoor space.

17. The method of claim 12, wherein the sensing data comprises a magnetic field value, a Wi-Fi value, a cellular value, and/or an image captured by a camera of the electronic device.

18. The method of claim 12, comprising mapping the sensing data to a particular space and/or an object arranged in the particular space using an augmented reality technology based on storing the first virtual marker.

19. The method of claim 12, wherein the sensing data comprises sensing values of an accelerometer and/or a gyro sensor included in a sensor module of the electronic device based on the electronic device moving and/or movement information about the electronic device based on the sensing values.

20. The method of claim 12, comprising performing first sharing to register the first virtual marker as a shared virtual marker and sharing the first virtual marker with an external electronic device and/or second sharing to share a second virtual marker generated in the external electronic device and registered as the shared virtual marker.
